(19) United States
(12) Patent Application Publication
(10) Pub. No.: US 2009/0201699 A1
(43) Pub. Date: Aug. 13, 2009

(54) Planar Illumination Device and Manufacturing Method of Same

(75) Inventor: Yasuo Ohno, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., Kitasaku-gun (JP)

(21) Appl. No.: 12/084,635

(22) PCT Filed: Oct. 18, 2006
(86) PCT No.: PCT/JP2006/320776

§ 371 Date: May 21, 2008

(30) Foreign Application Priority Data
Nov. 21, 2005 (JP) 2005-335986

(51) Int. Cl. F21V 7/04

(52) U.S. Cl. 362/634

(57) ABSTRACT

A planar illumination device in which workability of a filling work of a heat conduction agent is improved and a heat generated from a point-like light source is efficiently radiated so as to achieve high brightness. In a planar illumination device 1 according to the present invention, a recess portion 23 is formed on a part of a face on which a point-like light source 3 is mounted in a double-sided flexible print circuit board 10, a bottom face 22 of the recess portion 23 is made of a conductor pattern 7R on the opposite side 10R of a side 10F on which the point-like light source is mounted in the double-sided flexible print circuit board 10, and a heat conducting resin 11 is filled in a space constituted by the recess portion 23 and the mounting face 3b of the point-like light source 3. The double-sided flexible print circuit board 10 is preferably mounted on a radiator plate 5a using a heat conducting tape 12.

### TECHNICAL FIELD

The present invention relates to a side-light-type planar illumination device and particularly to a planar illumination device used as illuminating means of a liquid crystal display device.

### BACKGROUND ART

As an auxiliary light source for a liquid crystal display device used for a cellular phone or the like, a side-light type planar illumination device in which a primary light source is arranged on a side end face of a light guide plate is mainly used (hereinafter the side end face on which the primary light source is arranged is also called an incoming-light face). As the primary light source of a side-light-type planar illumination device, a cold-cathode lamp has been used, but currently, a point-like light source such as a white LED (hereinafter referred to simply as LED) which is more excellent in handling, easier in size reduction and better in impact resistance than the cold-cathode lamp is used in many cases. Application fields of the planar illumination device using such a point-like light source tend to expand, and application not only as a small-sized liquid crystal display device mounted on a cellular phone or the like but also as an auxiliary light source of a liquid crystal display device used in an in-vehicle navigator with a relatively large display size, for example, is being discussed.

In order to increase brightness of the side-light type planar illumination device and to respond to the expansion of an illumination area, it is preferable to increase an electric current to be supplied to each LED or to increase the number of LEDs in use. However, when the electric current supplied to the LED or the number thereof is increased, a heat amount generated from the LED is also increased and there is a problem that light emitting efficiency of the LED is lowered by temperature rise.

Therefore, various methods are examined to effectively let go the heat generated from the LED to the outside, and as a planar illumination device 1 shown in FIG. 5, for example, in a planar illumination device having a light guide plate 2, a flexible print circuit board (hereinafter also referred to as FPC) 4 on which an LED 3 is mounted, and a frame 5 integrally holding them, it is proposed that the frame 5 is formed by a metal material with excellent heat conductance such as aluminum and when the LED 3 is arranged on a side end face 2a of the light guide plate 2, the FPC 4 is bonded to a radiator plate 5a made of a side wall of the frame 5 so that radiation characteristic of the heat generated from the LED 3 is improved.

In such a light source portion made of the FPC 4 on which the LED 3 is mounted and the radiator plate 5a, when the FPC 4 and the radiator plate 5a are to be bonded together, a heat conduction agent is preferably interposed between them. FIG. 6 is a sectional view illustrating a configuration example of such a light source portion. In the light source portion 15 shown in FIG. 6, the FPC 4 is provided with a base film 6 made of polyimide and the like, a conductor pattern 7 formed by patterning copper foils and the like laminated on the base film 6 and a cover film 8 made of polyimide and the like, and a through hole 9 is provided at a location opposite a rear face (mounting face) 3b of the LED 3 when the LED 3 is mounted.

A manufacturing process of the light source portion 15 shown in FIG. 6 is as follows. First, the LED 3 is mounted on a surface 4F side of the FPC 4 on which the through hole 9 is provided in advance, and then, a heat conduction agent 11 is filled from a back face 4R side of the FPC 4 in a recess portion made of the through hole 9 and the mounting face 3b of the LED 3, and then, the back face 4R of the FPC 4 and the radiator plate 5a are fixed together by the heat conduction agent 12. At this time, from the viewpoint of workability of radiation efficiency and an assembling work, a heat conducting resin having fluidity is usually used for the heat conduction agent 11, and a heat conducting resin molded in a solid tape state at least at a room temperature (hereinafter also referred to as heat conducting tape) is used for the heat conduction agent 12. Such configuration of the light source portion 15 is advantageous in improvement of radiation characteristics since a radiation path not through a base film 6 with low heat conduction between the LED 3 as the heat source and the radiator plate 5a is formed.

As another configuration of the light source portion, it is also proposed that a through hole penetrating the through hole 9 of the FPC 4 is also provided on the radiator plate 5a and the heat conduction agent (heat conducting adhesive) is filled into the through hole from the rear face side of the radiator plate 5a (See Patent Document 1, for example).

Patent Document 1: Japanese Unexamined Patent Application Publication No. 2002-162626 (claims 1, 3, FIGS. 1 and 2)

### DISCLOSURE OF INVENTION

### Problems to be Solved by the Invention

At the light source portion 15 shown in FIG. 6, in order to efficiently let go the heat generated from the LED 3 to the radiator plate 5a, the through hole 9 provided at the FPC 4 is preferably made as large as possible and a contact area between the mounting face 3b of the LED 3 and the heat conducting resin 11 is made as large as possible. However, if the through hole 9 is provided on the FPC 4 and moreover, its area is made large, a narrow portion is generated in the periphery of the through hole 9 of the FPC 4, which makes strength of the FPC 4 insufficient. Thus, in the manufacturing process of the planar illumination device 1, there is a problem that deformation or disconnection can easily occur in the FPC 4 before mounting of the LED 3.

As the heat conduction agent to be filled in the through hole 9, the heat conducting resin 11 having fluidity is preferable as mentioned above, but after the heat conducting resin 11 is filled in the recess portion made of the through hole 9 and the mounting face 3b of the LED 3, transfer/adhesion of the heat conducting resin 11 to another spot can easily occur during fastening work of the FPC 4 to the radiator plate 5a by the heat conducting tape 12, and a particular attention should be paid so that an outgoing face 3a of the LED 3 should not be damaged, stained or the like. As such, there is a problem in workability in the manufacturing process in the conventional configuration of the light source portion 15 shown in FIG. 6.

On the other hand, Patent Document 1 describes that the light source portion is manufactured by a serials of processes of, first, affixing and fixing the FPC 4 to the radiator plate 5a by an adhesive and then, after drilling a through hole penetrating the radiator plate 5a and the FPC 4, mounting the LED 3 on the FPC 4 and then, embedding a heat conducting adhesive filler in the through hole and drying and solidifying it. With such member configuration and manufacturing process, though the above problems do not occur, there is a fear about rise in costs accompanying increase of procurement of new facilities and manufacturing processes required to put the processes in practice.

The present invention was made in view of the above problems and has an object to improve the workability of the filling work of the heat conduction agent and to provide a planar illumination device that can efficiently radiate heat generated from a point-like light source and achieve high brightness.

### Means for Solving the Problems

In order to achieve the above objects, in the planar illumination device according to the present invention comprising a light guide plate, a point-like light source arranged on a side end face of the light guide plate, and a double-sided flexible print circuit board on which the point-like light source is mounted, in the double-sided flexible print circuit board, a recess portion is formed on a part of a face on which the point-like light source is mounted; a bottom face of the recess portion is made of a conductor pattern on the side opposite the side on which the point-like light source is mounted in the double-sided flexible print circuit board; and a heat conducting resin is filled in a space constituted by the recess portion and a mounting face of the point-like light source.

In the planar illumination device according to the present invention, by forming not a through hole but the recess portion having the conductor pattern on the side opposite the side on which the point-like light source is mounted as the bottom face on the double-sided flexible print circuit board, a space in which the heat conducting resin is filled is formed without lowering strength of the double-sided flexible print circuit board.

Also, in the planar illumination device according to the present invention, the filling work of the heat conducting resin is preferably carried out from the side of the face on which the point-like light source is mounted of the double-sided flexible print circuit board before mounting of the point-like light source. Therefore, the filling work of the heat conducting resin can be carried out substantially during a mounting process of the point-like light source using a mounting device provided with a filling function, for example, and the workability can be drastically improved. Moreover, the heat conducting resin is held in the space constituted by the recess portion and the mounting face of the point-like light source after the point-like light source is mounted on the double-sided flexible print circuit board, and there is no need to worry about transfer/adhesion of the heat conducting resin to another member, which contributes to improvement of workability of the subsequent processes.

In the present invention, the double-sided flexible print circuit board is preferably mounted on the radiator plate using the heat conducting tape, by which a radiation path of high heat conduction is constituted from the point-like light source as the heat source to the radiator plate through the heat conducting resin, conductor pattern, and heat conducting tape, and the heat generated from the point-like light source is efficiently conducted to the radiator plate and radiated by the radiator plate. By using the heat conducting tape in a stable solid state at least at a room temperature, workability of the mounting work of the double-sided flexible print circuit board on the radiator board is improved.

### ADVANTAGES OF THE INVENTION

Since the present invention is configured as above, workability of the filling work of the heat conduction agent can be improved and the heat generated from the point-like light source can be efficiently radiated, by which high brightness of the planar illumination device can be achieved.

### BRIEF DESCRIPTION OF DRAWINGS

FIG. 1 is a sectional view illustrating an essential part of a light source portion in a first embodiment of the present invention;

FIG. 2 is a top view illustrating an essential part of a double-sided flexible print circuit board used in the light source portion shown in FIG. 1;

FIG. 3 is a sectional view illustrating an essential part of a light source portion in a second embodiment of the present invention;

FIG. 4 is a top view illustrating an essential part of a double-sided flexible print circuit board used in the light source portion shown in FIG. 3;

FIG. 5 is a perspective view illustrating a configuration example of a conventional planar illumination device; and

FIG. 6 is a sectional view illustrating a configuration example of a light source portion of a conventional planar illumination device.

### REFERENCE NUMERALS

1 planar illumination device
2 light guide plate
2a side end face (incoming-light face)
3 point-like light source (LED)
3b mounting face
5a radiator plate
10, 40 double-sided flexible print circuit board
11 heat conducting resin
12 heat conducting tape
7F, 47F conductor pattern (front face side)
7R, 47R conductor pattern (back face side)
22 bottom face
23 recess portion

### BEST MODES FOR CARRYING OUT THE INVENTION

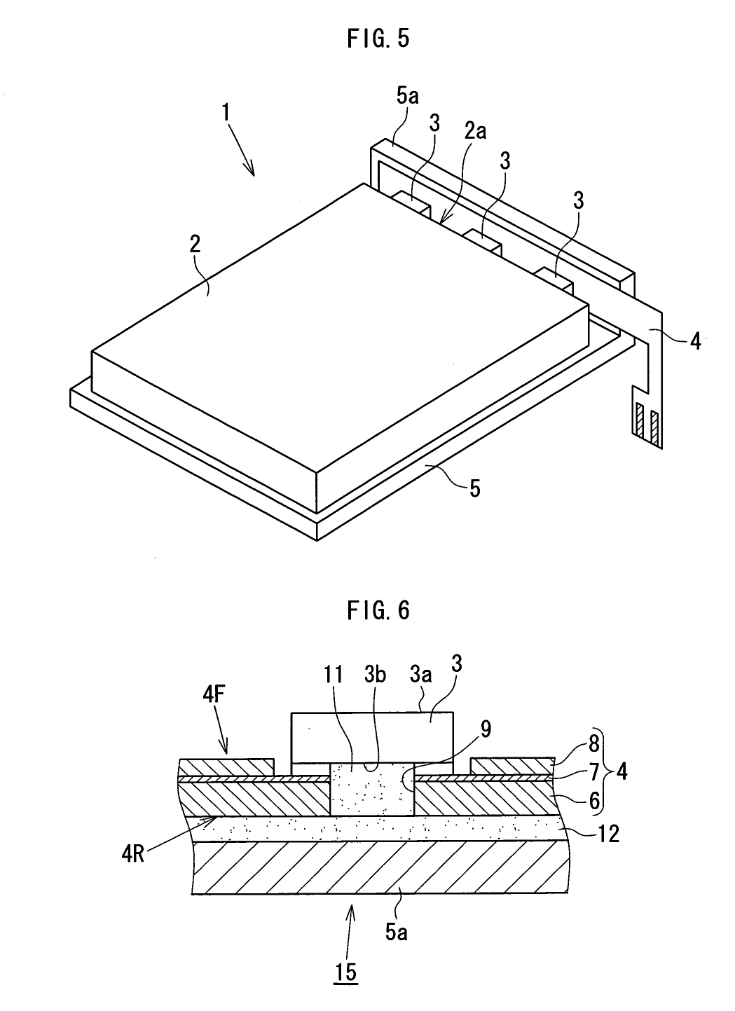

Embodiments of the present invention will be described referring to the attached drawings, but each drawing is for explanation and does not necessarily reflect actual shapes or dimensions accurately. Since the planar illumination device according to the present invention is the same as the planar illumination device shown in FIG. 5 in its basic configuration, description on duplicated portions will be omitted, and configuration of the light source portion, which is a major characteristic portion of the present invention, will be described in detail. At that time, the same reference numerals are given to the same components in the planar illumination device 1 shown in FIG. 5 and referred to.

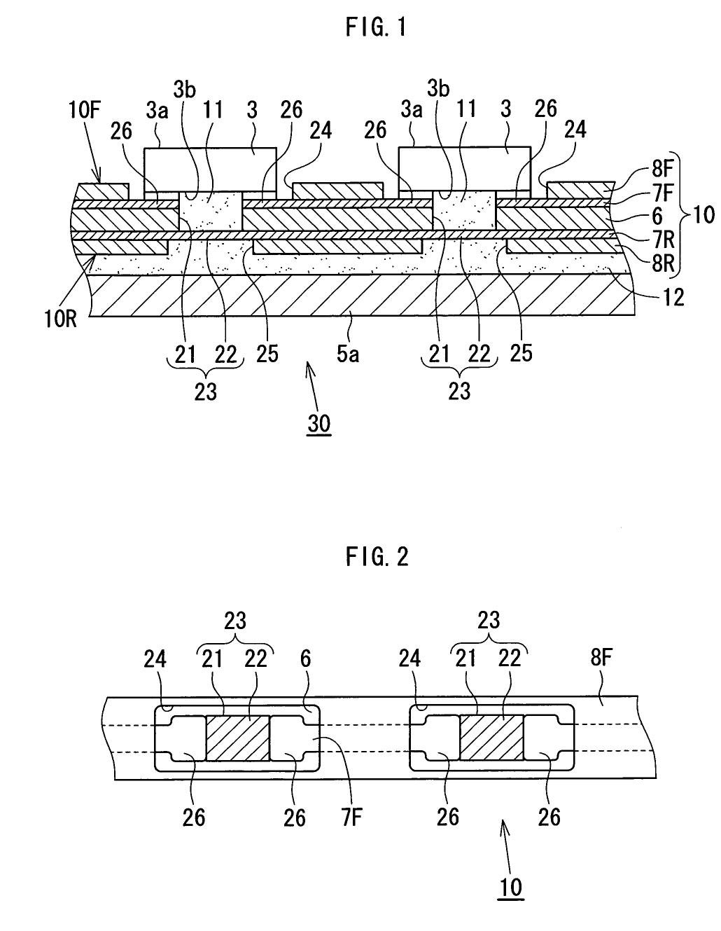

FIG. 1 is a sectional view illustrating an essential part of a light source portion 30 in a first embodiment of the present invention, and FIG. 2 is a top view illustrating an essential part of a double-sided flexible print circuit board 10 used in the light source portion 30. In this embodiment, the double-sided flexible print circuit board (hereinafter referred to as FPC) 10 is provided with the base film 6 made of polyimide and the like, conductor patterns 7F, 7R formed by patterning copper foil and the like laminated on both principal faces of the base film 6, and cover films 8F, 8R made of polyimide and the like laminated so as to cover the respective conductor patterns 7F, 7R.

The conductor pattern 7F on the side of a surface 10F of the FPC 10 includes a land portion 26 on which a white LED, which is a point-like light source in this embodiment (hereinafter referred to as LED) 3 is mounted, the cover film 8F has an opening portion 24 exposing at least these land portions 26, and the LED 3 is mounted on the side of the surface 10F of the FPC 10. The side of a back face 10R of the FPC 10 is fixed to the radiator plate 5a using the heat conducting tape 12.

In this embodiment, in the FPC 10, an opening portion 21 is provided at a location opposed to the mounting face 3b of the LED 3 of the base film 6, the conductor pattern 7R on the back race 10R side is patterned leaving at least a portion 22 immediately below the opening portion 21, and a recess portion 23 with the portion 22 immediately below the opening portion 21 as the bottom face is formed. In the light source portion 30 in this embodiment, the heat conducting resin 11 is filled in a space constituted by the recess portion 23 formed in this FPC 10 and the mounting face 3b of the LED 3 mounted on the FPC 10. In the cover film 8R on the back face 10R side of the FPC 10, an opening portion 25 is provided so that the bottom face 22 of the recess portion 23 is also exposed to the back face 10R side.

In this embodiment, the heat conducting resin 11 and the heat conducting tape 12 are made of a resin material having electric insulation and high heat conduction such as silicon resin composition or an arbitrary appropriate resin composition containing non-conductive heat conducting filler such as alumina, aluminum nitride, silicon carbide and the like. The heat conducting resin 11 is preferably a heat conduction agent of a type having considerable fluidity and not requiring a drying/solidifying process and it may use a silicon resin composition formed in an oil state, grease state or paste state, for example.

The heat conducting tape 12 is in a stable solid state at least at a room temperature and preferably made of a heat conducting resin composition having considerable tackiness or adhesion and a shape following property molded into a tape state. For example, the heat conducting tape 12 may be molded by coating a polyethylene terephthalate film or the like with separation processing applied with an acrylic resin composition. Alternatively, the heat conducting tape 12 may use a resin composition softened or melted at a high temperature so as to further reduce heat resistance at a contact portion between the FPC 10 and the radiator plate 5a at heat generation of the LED 3.

By the above configuration, at the light source portion 10 in this embodiment, a radiation path with high heat conduction is constituted from the LED 3 as the heat source to the radiation plate 5a through the heat conducting resin 11, the bottom face 22 made of the conductor pattern 7R of the recess portion 23, and the heat conducting tape 12, and the heat generated from the LED 3 can be efficiently conducted to the radiator plate 5a and radiated.

At this time, since the FPC 10 constitutes the space in which the heat conduction agent 11 is filled not by a through hole but by the recess portion 23 provided with the bottom face 22, strength of the FPC 10 before mounting of the LED 3 is not lowered. Also, since there is no through hole for filling the heat conduction agent 11, a step present on the back face 10R side of the FPC 10 is only the thickness portion of the cover film 8R in the opening portion 25, and the step can be absorbed by deformation of the heat conducting tape 12. Therefore, on the back face 10R side of the FPC 10, without executing a treatment such as filling separate heat conduction agents to the portion immediately below the LED 3 and the other portions, the entire back face 10R side of the FPC 10 can be filled without a gap by adhesion of a single heat conducting tape 12, by which workability and radiation efficiency of the heat generated from the LED 3 are improved.

The light source portion 30 in this embodiment covers the back face 10R side of the FPC 10 by the heat conducting tape 12 having electric insulation, and as long as protection and insulation of the conductor pattern 7R are sufficiently ensured by the heat conducting tape 12, a cover film thinner than the cover film 8F on the front face 10F side may be used as the cover film 8R or the FPC 10 may be configured without using the cover film 8R. In these cases, radiation efficiency of the heat generated from the LED 3 is further improved.

Next, a preferable manufacturing process of the light source portion 30 in this embodiment will be described.

First, on a copper-clad laminate made by bonding a copper foil on both principal faces of the base film 6 made of polyimide and the like, a through hole for conduction, not shown, is formed as necessary, and the conductor patterns 7F, 7R are formed by etching or the like. Then, the opening portion 21 is formed at a predetermined location on the front face 10F side of the base film 6 by chemical etching or the like. Then, the cover film 8F and (if necessary) the cover film 8R are laminated by thermocompression and the like so as to complete the FPC 10.

Then, the heat conducting resin 11 is filled in the recess portion 23 of the FPC 10 and then, the LED 3 is mounted on the land portion 26. Then, the back face 10R of the FPC 10 and the radiator plate 5a are fastened together using the heat conducting tape 12, and the FPC 10 is mounted on the radiator plate 5a. By this arrangement, the light source portion 30 is completed.

As mentioned above, in the preferable manufacturing process of the light source portion 30, the filling work of the heat conducting resin 11 is carried out immediately before mounting of the LED 3 and particularly using a mounting device provided with a filling function, the mounting can be conducted substantially during the mounting process of the LED 3. As a result, the workability of the filling work is drastically improved. Also, since the heat conducting resin 11 is held in the space constituted by the mounting face 3b of the LED 3 and the recess portion 23 after the LED 3 is mounted, the subsequent mounting process of the FPC on the radiator plate 5a can be conducted without considering transfer, adhesion and the like of the heat conducting resin 11 to another member, by which the workability is also drastically improved. As a result, a heat conducting resin with fluidity, which is advantageous in close adhesion to a heat generating body, filling performance in the space and the like can be preferably used as the heat conducting resin 11.

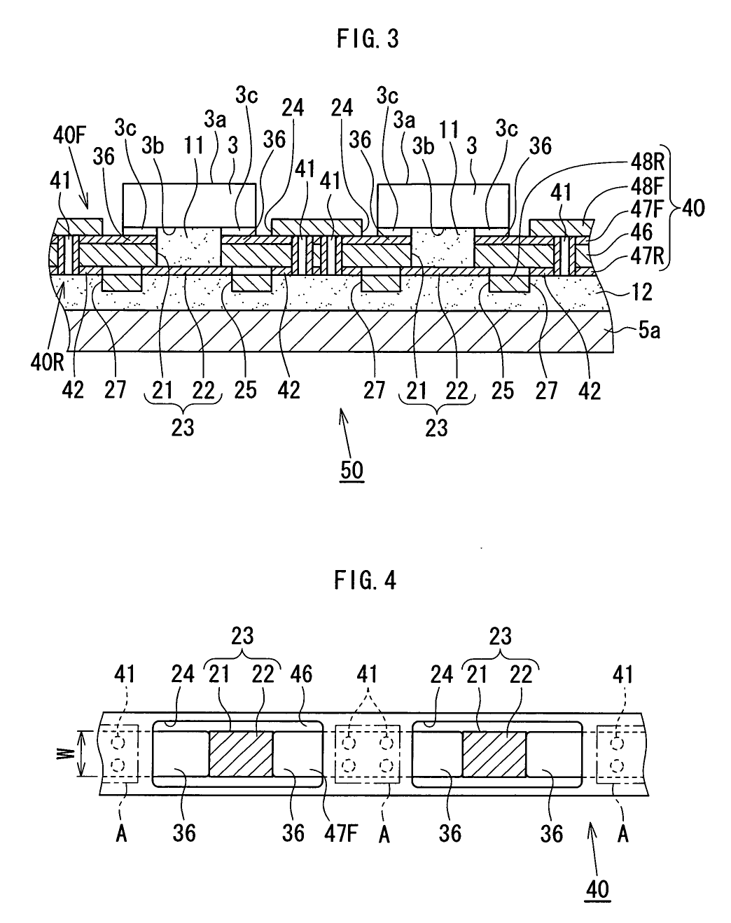

Next, a second embodiment of the present invention will be described referring to FIGS. 3 and 4, but in the description below, the same reference numerals are given to the components similar to those in the first embodiment and description of the duplicated portions will be omitted.

FIG. 3 is a sectional view illustrating an essential part of a light source portion 50 in the second embodiment of the present invention, and FIG. 4 is a top view illustrating an essential part of an FPC 40 used in the light source portion 50. The FPC 40 in this embodiment has basic configuration similar to the FPC 10 and the light source portion 30 shown in FIGS. 1 and 2 and comprises a base film 46 made of polyimide and the like, conductor patterns 47F, 47R formed by patterning a copper foil and the like laminated on both principal faces of the base film 46, and a cover film 48F and (when necessary) a cover film 48R made of polyimide and the like laminated so as to cover the respective conductor pattern 47F, 47R, the heat conducting resin 11 is filled in a space constituted by the recess portion 23 provided in the FPC 40 and the mounting face 3b of the LED 3, a back face 40R side of the FPC 40 is fastened to the radiator plate 5a using the heat conducting tape 12, and a radiation path with high heat conduction is constituted from the LED 3 as the heat source to the radiator plate 5a through the heat conducting resin 11, the bottom face 22 made of the conductor pattern 47R of the recess portion 23, and the heat conducting tape 12. If the cover film 48R is provided on the back face side of the FPC 40, the opening portion 25 is provided on the cover film 48R so that the bottom face 22 of the recess portion 23 is also exposed to the back face 40R side.

Moreover, in the FPC 40 in this embodiment, a region A continuing to a land portion 36 of the conductor pattern 47F of the front side 40F, a through hole 41 connecting to a portion of the conductor pattern 47R on the corresponding back face 40R side is formed, and in the conductor pattern 47R on the back face 40R side, a radiation pattern 42 having an area at least including the through hole 41 is formed. When the cover film 48R on the back face 40R side is used, the opening portion 27 to expose the radiation pattern 42 is provided on the cover film 48R.

With the above configuration, in the light source portion 50 in this embodiment, in addition to the above-mentioned radiation path in the light source portion 30 shown in FIG. 1, a radiation path is constituted to the radiator plate 5a through an electrode terminal 3c of the LED 3, the land portion 36 of the conductor pattern 47F, the through hole 41, the radiation pattern 42, and the heat conducting tape 12, the radiation efficiency of the heat generated from the LED 3 is further improved.

As shown in FIG. 2, the portion continuing to the land portion 36 of the conductor pattern 47F has preferably the same width W as the land portion 36. By constituting the conductor pattern 47F as such, an area for forming as many through holes 41 as possible can be ensured in the region A, the heat resistance between the land portion 36 and the region A can be reduced, and the heat generated from the LED 3 can be efficiently let go to the radiation pattern 42 from the electrode terminal 3c of the LED 3. At that time, at the conductor pattern 47F having substantially the same width W as the land portion 36, self-alignment effectively functions at least in the thickness direction of the incoming-light face 2a (See FIG. 5) of the light guide plate 2 at mounting of the LED 3 on the land portion 36 and the mounting position is aligned, and light combining efficiency between the light guide plate 2 and the LED 3 is not lowered. Moreover, the portion continuing to the land portion 36 of the conductor pattern 47F preferably has the width larger than the width W of the land portion 36 in the region A, by which a sectional area required for the conductor pattern 47F can be ensured and as many through holes 41 as possible constituting the radiation path can be provided.

A preferable manufacturing process of the light source portion 50 in this embodiment is basically the same as the manufacturing process of the light source portion 30, but in the process of forming the through hole for conduction, not shown, and the conductor patterns 47F, 47R on the copper-clad laminate made by bonding a copper foil on both principal faces of the base film 46, the through hole 41 and the radiation pattern 42 are formed with these components, which is a different point.

In the above-mentioned conductor patterns 7R, 47R on the back face 10R, 40R side of the FPC 10, 40, the pattern 22 constituting the bottom face of the recess portion 23 and the radiation pattern 42 may have arbitrary appropriate shape and area as long as at least a predetermined area is covered, respectively.

An electric connection mode of the patterns 22, 42 such as whether or not to connect to a specific wiring pattern (ground line, for example) included in the conductor patterns 7R, 47R or to be electrically insulated from those wiring patterns or the like, for example, is set as appropriate according to a specific design specification of the FPC 10, 40. Similarly, if possible, the through hole 41 of the FPC 40 may also function as the through hole for conduction.

The preferred embodiments of the present invention have been described above, but the light source portion of the planar illumination device according to the present invention is not limited to the above-mentioned embodiments. For example, if the thickness of the cover film on the back face side constituting the FPC is thin enough to ignore the influence on the heat conduction from the LED to the radiator plate, an opening portion as the opening portion 25 shown in FIGS. 1 and 3 does not necessarily have to be provided on the cover film on the back face side but it may be so configured that the cover film is laminated on the entire surface on the back face side of the FPC.

Also, if the thickness of a member for fastening the FPC to the radiator plate can be thinned so that the heat resistance can be ignored, a member with high heat conduction as the heat conducting tape 12 shown in FIGS. 1 and 3 does not necessarily have to be used but a usual adhesive tape or an adhesive may be applied.

1. A planar illumination device comprising: a light guide plate; a point-like light source arranged on a side end face of the light guide plate; and a double-sided flexible print circuit board on which the point-like light source is mounted, wherein:
in the double-sided flexible print circuit board, a recess portion is formed on a part of a face on which said point-like light source is mounted; a bottom face of the recess portion is made of a conductor pattern on the side opposite the side on which the point-like light source is mounted in said double-sided flexible print circuit board; and a heat conducting resin is filled in a space constituted by the recess portion and a mounting face of the point-like light source.

2. A planar illumination device according to claim 1, wherein the double-sided flexible print circuit board is mounted on a radiator plate using a heat conducting tape.
